(19) United States
(12) Patent Application Publication
(10) Pub. No.: US 2004/0078781 A1
(43) Pub. Date: Apr. 22, 2004

(54) Algorithm for creating and translating cross-platform compatible software

(76) Inventors: Ronald Stephen Novy, Covina, CA (US); Jesse Iolani Kellii, Riverside, CA (US)

Correspondence Address: Ronald S. Novy, 1313 Calvados Ave., Covina, CA, 91722, US

(21) Appl. No.: 10/271,384

(22) Filed: Oct. 16, 2002

(51) Int. Cl. G06F 9/44; G06F 9/45

(52) U.S. Cl. 717/114; 717/106; 717/136

(57) ABSTRACT

The algorithm for creating and translating cross-platform compatible software is a set of processes that create or translate software. The creation process involves writing the software in the language of choice then compiling it into a standard Cross-platform assembly language binary. Then the Translator software, which is specific to the processor and/or operating system the software is executed on, translates the Cross-platform assembly language into the processors specific assembly language and also processes any graphics or other information the software might need on that platform.

### REFERENCES

References included with this specification are 2 compact disks containing the following files.

00XPCDef.h—Contains 646 lines of C++code. Defines a partial list of basic and advanced assembly language instructions used in the ‘Advanced virtual platform assembly language’.

XPC.doc—This is the revised version of the specification or specifically this document, including claims and graphics, in Microsoft Word format.

### BRIEF BACKGROUND/SUMMARY OF INVENTION

The ‘Algorithm for creating and translating cross-platform compatible software’ or the ‘XPC’ algorithm was created for several different reasons. One was to allow hardware technology to advance at a quicker pace by eliminating the need for hardware backward compatibility. The second reason was to allow software makers to encrypt there advanced software or new technology so that they do not have to worry about ‘hackers’ or ‘crackers’ stealing their technology by backward engineering or decompiling the software. Another advantage to using the ‘XPC’ algorithm would be the ability to compress the entire application without having to add a ‘stub’ or an extra set of software commands to the binary to decompress it at run time.

### DEFINITIONS OF TERMS USED IN THIS DOCUMENT

### XPC or Cross-platform Compatibility

The ability of software to function properly with different computer systems and technology.

### Executable Software

Executable software is the binary version of software that a CPU can use and understand.

### XPC Binary

A version of XPC software that can be compressed, encrypted, and translated into ‘Executable software’.

### Advanced Virtual Platform

A state-of-the-art platform that can be translated or emulated so that to be compatible with all other conceivable platforms.

### Assembly Language

An assembly language is a human interface language that can be directly translated into a CPU's raw binary language.

### Advanced Virtual Platform Assembly Language

A human interface language that can be translated to any CPU binary language.

### Translator

A translator is a piece of hardware or software that translates software into a CPU's native binary language.

### BRIEF DESCRIPTION OF DRAWINGS

FIG. 1 illustrates the current way that hardware, operating systems, and user software interact based on current windows technology.

FIG. 2 illustrates how cross-platform compatible software, or ‘XPC’ software, can be executed on different platforms and/or different operating systems through the proper translator.

FIG. 3 illustrates how a hardware translator can be implemented to translate the operating system from ‘XPC’ binary files into code that is compatible with the systems CPU and how it can work in parallel with software written specifically for the operating system and CPU combination. It also illustrates how a second translator can translate other ‘XPC’ software to work directly with the operating system.

### DETAILED DESCRIPTION

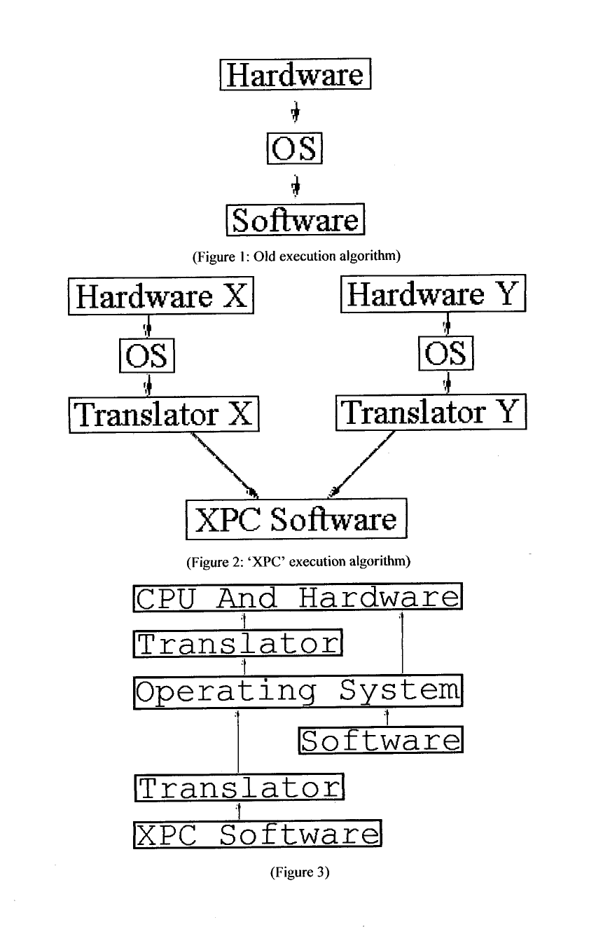

The algorithm for creating and translating cross-platform compatible software, or the ‘XPC’ algorithm, is a more advanced and also more efficient process for creating software (Compare FIG. 1 and FIG. 2). This process of creating software is made easier by providing an ‘Advanced virtual platform’ that provides the software engineer with an advanced, state-of-the-art assembly language (An example of the ‘Advanced virtual platform assembly language’ is included on the compact disk submitted with this specification). It also provides a binary version of the assembly language that can be distributed and translated into ‘executable software’ that is compatible with the CPU and platform it is being run on. Since the ‘Advanced virtual platform’ is based on an assembly language, other software languages such as BASIC, C, C++, Pascal, and others can be compiled into an ‘XPC binary’ instead of a platform specific language. Once software is created and converted into an ‘XPC binary’ it can also be encrypted to provide security against viruses and to keep hackers from steeling technology or modifying the software. This algorithm provides software compatibility between computer platforms through a translator. The translator is either written in the CPU's native language so that each platform will need its own unique translator, or is a set of translation hardware in the system. This algorithm also allows for backward compatibility with old technology and allows for 100% forward compatibility with new technology that did not exist at the time when the software was created. The ‘XPC’ binary is an excellent way to create state-of-the-art software, and Internet and web site related software and could replace the Internet languages currently in use.

native language. See FIG. 3 for a visual explanation of how the translator fits into a computer platform.

2.) When a binary created with the ‘Advanced virtual platform assembly language’ is needed the translator is activated and the binary is loaded into memory.

a.) The translator then processes the binary by decrypting and or decompressing it if necessary.

b.) When all the software is translated the operating system is then given the location of the software in memory and the type of binary it has translated so that the system software can act according to the content of the software and the type of software.

### The Advanced Virtual Platform Assembly Language

The following is an unpublished example of the advanced virtual platform assembly language.

/* XPC File format definition
** written by Ron S. Novy
** File name:00XPCDef.h Version 1.0
*/
/* -Conversion table
** OWord = 16 BYTES = 128bits
** QWord = 8 BYTES = 64-bits
** DWord = 4 BYTES = 32-bits
** Triple= 3 BYTES = 24-bits For compatibility with sound mixing
devices.
** Word = 2 BYTES = 16-bits
*/
enum V_ASM_e {
// First instruction is pretty self explanitory

| | | |
|---|---|---|
| NOP | , | //- NOP No operation. |

// Instruction for DATE, TIME, and CPU CLOCKS

| | | |
|---|---|---|
| GETDAY | , | //- GETDAY A(8b) = current day of month |
| SETDAY | , | //- SETDAY current day of month = A(8b) |
| GETMONTH | , | //- GETMONTH A(8b) = current Month |
| SETMONTH | , | //- SETMONTH current Month = A(8b) |
| GETYEAR | , | //- GETYEAR A(128b) = current year |
| SETYEAR | , | //- SETYEAR current year = A(128b) |
| GETHOUR | , | //- GETHOUR A(8b) = current Hour |
| SETHOUR | , | //- SETHOUR current Hour = A(8b) |
| GETMIN | , | //- GETMIN A(8b) = current Minuet |
| SETMIN | , | //- SETMIN current Minuet = A(8b) |
| GETSEC | , | //- GETsec A(8b) = current second |
| SETSEC | , | //- SETSEC current second = A(8b) |
| GETTIMER | , | //- GETTIMER A(32b) = Milliseconds since |
| | | // the CPU was started. |
| GETCLOCK | , | //- GETCLOCK A(64b) = CPU clock ticks since |
| | | // the computer was started. |

// Instruction MOVOxx = Clear high bits of OWord ‘to’ and move data

| | | |
|---|---|---|
| MOVO8 | , | //- MOVO 8-bits to(128b) = from(8b) |
| MOVO16 | , | //- MOVO 16bits to(128b) = from(16b) |
| MOVO24 | , | //- MOVO 24bits to(128b) = from(24b) |
| MOVO32 | , | //- MOVO 32bits to(128b) = from(32b) |
| MOVO64 | , | //- MOVO 64bits to(128b) = from(64b) |

// Instruction MOVQxx = Clear high bits of QWord ‘to’ and move data

| | | |
|---|---|---|
| MOVQ8 | , | //- MOVQ 8-bits to(64b) = from(8b) |
| MOVQ16 | , | //- MOVQ 16bits to(64b) = from(16b) |
| MOVQ24 | , | //- MOVQ 24bits to(64b) = from(24b) |
| MOVQ32 | , | //- MOVQ 32bits to(64b) = from(32b) |

// Instruction MOVDxx = Clear high bits of DWord ‘to’ and move data

| | | |
|---|---|---|
| MOVD8 | , | //- MOVD 8-bits to(32b) = from(8b) |
| MOVD16 | , | //- MOVD 16bits to(32b) = from(16b) |
| MOVD24 | , | //- MOVD 24bits to(32b) = from(24b) |

// Instruction MOVTxx = Clear high bits of Tri ‘to’ and move data

| | | |
|---|---|---|
| MOVT8 | , | //- MOVT 8-bits to(24b) = from(8b) |
| MOVT16 | , | //- MOVT 16bits to(24b) = from(16b) |

// Instruction MOVWxx = Clear high bits of Word ‘to’ and move data

| | | |
|---|---|---|
| MOVW8 | , | //- MOVW 8-bits to(16b) = from(8b) |

/*
** Instruction BSWAPxx Convert big-endian to/from little-endian
** BSWAP Example char 32bit[4]= BEFORE = ‘1234’ AFTER = ‘4321’
*/

| | | |
|---|---|---|
| BSWAP16 | , | //- BSWAP 16-bit endian conversion |
| BSWAP24 | , | //- BSWAP 24-bit endian conversion |
| BSWAP32 | , | //- BSWAP 32-bit endian conversion |
| BSWAP64 | , | //- BSWAP 64-bit endian conversion |
| BSWAP128 | , | //- BSWAP 128bit endian conversion |

// Instruction MOVBLCKxx moves a block of data to A from B

| | | |
|---|---|---|
| MOVBLCK8 | , | //- MOVBLCK moves C Bytes to A from B |
| MOVBLCK16 | , | //- MOVBLCK moves C Words to A from B |
| MOVBLCK24 | , | //- MOVBLCK moves C Triples to A from B |
| MOVBLCK32 | , | //- MOVBLCK moves C DWords to A from B |
| MOVBLCK64 | , | //- MOVBLCK moves C QWords to A from B |
| MOVBLCK128 | , | //- MOVBLCK moves C OWords to A from B |

// Instruction MOVxx

| | | |
|---|---|---|
| MOV8 | , | //- Mov 8-bits to, from |
| MOV16 | , | //- Mov 16-bits to, from |
| MOV24 | , | //- Mov 24-bits to, from |
| MOV32 | , | //- Mov 32-bits to, from |
| MOV64 | , | //- Mov 64-bits to, from |
| MOV128 | , | //- Mov 128bits to, from |

// Instruction XCHGxx

| | | |
|---|---|---|
| XCHG8 | , | //- XCHG 8-bits Swaps A, B |
| XCHG16 | , | //- XCHG 16-bits Swaps A, B |
| XCHG24 | , | //- XCHG 24-bits Swaps A, B |
| XCHG32 | , | //- XCHG 32-bits Swaps A, B |
| XCHG64 | , | //- XCHG 64-bits Swaps A, B |
| XCHG128 | , | //- XCHG 128bits Swaps A, B |

// Instruction PUSHxx

| | | |
|---|---|---|
| PUSH8 | , | //- PUSH 8-bits to stack |
| PUSH16 | , | //- PUSH 16-bits to stack |
| PUSH24 | , | //- PUSH 24-bits to stack |
| PUSH32 | , | //- PUSH 32-bits to stack |
| PUSH64 | , | //- PUSH 64-bits to stack |
| PUSH128 | , | //- PUSH 128bits to stack |

// Instruction POPxx

| | | |
|---|---|---|
| POP8 | , | //- POP 8-bits from stack |
| POP16 | , | //- POP 16bits from stack |
| POP24 | , | //- POP 24bits from stack |
| POP32 | , | //- POP 32bits from stack |
| POP64 | , | //- POP 64bits from stack |
| POP128 | , | //- POP 128bits from stack |

// Integer math. These instructions are compatible with signed and
// unsigned integers that can wrap arround on an overflow or underflow.
// Instruction IADDxx

| | | |
|---|---|---|
| IADD8 | , | //- IADD 8-bits to = to + from |
| IADD16 | , | //- IADD 16-bits to = to + from |
| IADD24 | , | //- IADD 24-bits to = to + from |
| IADD32 | , | //- IADD 32-bits to = to + from |
| IADD64 | , | //- IADD 64-bits to = to + from |
| IADD128 | , | //- IADD 128bits to = to + from |

// Instruction IADCxx add with carry

| | | |
|---|---|---|
| IADC8 | , | //- IADC 8-bits to = to + from + CFlag |
| IADC16 | , | //- IADC 16-bits to = to + from + CFlag |
| IADC24 | , | //- IADC 24-bits to = to + from + CFlag |
| IADC32 | , | //- IADC 32-bits to = to + from + CFlag |
| IADC64 | , | //- IADC 64-bits to = to + from + CFlag |
| IADC128 | , | //- IADC 128bits to = to + from + CFlag |

// Instruction ISUBxx

| | | |
|---|---|---|
| ISUB8 | , | //- ISUB 8-bits to = to − from |
| ISUB16 | , | //- ISUB 16-bits to = to − from |
| ISUB24 | , | //- ISUB 24-bits to = to − from |
| ISUB32 | , | //- ISUB 32-bits to = to − from |
| ISUB64 | , | //- ISUB 64-bits to = to − from |
| ISUB128 | , | //- ISUB 128bits to = to − from |

// Instruction ISBBxx Subtract with carry

| | | |
|---|---|---|
| ISBB8 | , | //- ISBB 8-bits to = to − from − CFlag |
| ISBB16 | , | //- ISBB 16-bits to = to − from − CFlag |
| ISBB24 | , | //- ISBB 24-bits to = to − from − CFlag |
| ISBB32 | , | //- ISBB 32-bits to = to − from − CFlag |
| ISBB64 | , | //- ISBB 64-bits to = to − from − CFlag |
| ISBB128 | , | //- ISBB 128bits to = to − from − CFlag |

// Instructions IINCxx

| | | |
|---|---|---|
| IINC8 | , | //- IINC 8-bits to = to + 1 |
| IINC16 | , | //- IINC 16-bits to = to + 1 |
| IINC24 | , | //- IINC 24-bits to = to + 1 |
| IINC32 | , | //- IINC 32-bits to = to + 1 |
| IINC64 | , | //- IINC 64-bits to = to + 1 |
| IINC128 | , | //- IINC 128bits to = to + 1 |

// Instructions IDECxx

| | | |
|---|---|---|
| IDEC8 | , | //- IDEC 8-bits to = to − 1 |
| IDEC16 | , | //- IDEC 16-bits to = to − 1 |
| IDEC24 | , | //- IDEC 24-bits to = to − 1 |
| IDEC32 | , | //- IDEC 32-bits to = to − 1 |
| IDEC64 | , | //- IDEC 64-bits to = to − 1 |
| IDEC128 | , | //- IDEC 128bits to = to − 1 |

// More Integer math. These instructions are a bit more complicated and
are
// thus seperated into signed and unsigned versions.
// Instruction UIMULxx Multiply unsigned integers.

| | | |
|---|---|---|
| UIMUL8 | , | //- UIMUL 8-bits to = to * from |
| UIMUL16 | , | //- UIMUL 16-bits to = to * from |
| UIMUL24 | , | //- UIMUL 24-bits to = to * from |
| UIMUL32 | , | //- UIMUL 32-bits to = to * from |
| UIMUL64 | , | //- UIMUL 64-bits to = to * from |
| UIMUL128 | , | //- UIMUL 128bits to = to * from |

// Instruction UIDIVxx Divide unsigned integers

| | | |
|---|---|---|
| UIDIV8 | , | //- UIDIV 8-bits to = to / from |
| UIDIV16 | , | //- UIDIV 16-bits to = to / from |
| UIDIV24 | , | //- UIDIV 24-bits to = to / from |
| UIDIV32 | , | //- UIDIV 32-bits to = to / from |
| UIDIV64 | , | //- UIDIV 64-bits to = to / from |
| UIDIV128 | , | //- UIDIV 128bits to = to / from |

// Instruction SIMULxx Multiply signed integers

| | | |
|---|---|---|
| SIMUL8 | , | //- SIMUL 8-bits to = to * from |
| SIMUL16 | , | //- SIMUL 16-bits to = to * from |
| SIMUL24 | , | //- SIMUL 24-bits to = to * from |
| SIMUL32 | , | //- SIMUL 32-bits to = to * from |
| SIMUL64 | , | //- SIMUL 64-bits to = to * from |
| SIMUL128 | , | //- SIMUL 128bits to = to * from |

//Instruction SIDIVxx Divide signed integers

| | | |
|---|---|---|
| SIDIV8 | , | //- SIDIV 8-bits to = to / from |
| SIDIV16 | , | //- SIDIV 16-bits to = to / from |
| SIDIV24 | , | //- SIDIV 24-bits to = to / from |
| SIDIV32 | , | //- SIDIV 32-bits to = to / from |
| SIDIV64 | , | //- SIDIV 64-bits to = to / from |
| SIDIV128 | , | //- SIDIV 128bits to = to / from |

// Saturated Integer math. These instructions are used for integers that are
// not supposed to wrap around on overflow or underflow and are insted
// maximized or minimized according to the integer type.
// Instruction SSADDxx signed saturated addition

| | | |
|---|---|---|
| SSADD8 | , | //- SSADD 8-bits to = to + from |
| SSADD16 | , | //- SSADD 16-bits to = to + from |
| SSADD24 | , | //- SSADD 24-bits to = to + from |
| SSADD32 | , | //- SSADD 32-bits to = to + from |
| SSADD64 | , | //- SSADD 64-bits to = to + from |
| SSADD128 | , | //- SSADD 128bits to = to + from |

// Instruction SSADCxx signed saturated addition with carry

| | | |
|---|---|---|
| SSADC8 | , | //- SSADC 8-bits to = to + from + CFlag |
| SSADC16 | , | //- SSADC 16-bits to = to + from + CFlag |
| SSADC24 | , | //- SSADC 24-bits to = to + from + CFlag |
| SSADC32 | , | //- SSADC 32-bits to = to + from + CFlag |
| SSADC64 | , | //- SSADC 64-bits to = to + from + CFlag |
| SSADC128 | , | //- SSADC 128bits to = to + from + CFlag |

// Instruction SSSUBxx signed saturated subtraction

| | | |
|---|---|---|
| SSSUB8 | , | //- SSSUB 8-bits to = to − from |
| SSSUB16 | , | //- SSSUB 16-bits to = to − from |
| SSSUB24 | , | //- SSSUB 24-bits to = to − from |
| SSSUB32 | , | //- SSSUB 32-bits to = to − from |
| SSSUB64 | , | //- SSSUB 64-bits to = to − from |
| SSSUB128 | , | //- SSSUB 128bits to = to − from |

// Instruction SSSBBxx signed saturated subtract with carry

| | | |
|---|---|---|
| SSSBB8 | , | //- SSSBB 8-bits to = to − from − CFlag |
| SSSBB16 | , | //- SSSBB 16-bits to = to − from − CFlag |
| SSSBB24 | , | //- SSSBB 24-bits to = to − from − CFlag |
| SSSBB32 | , | //- SSSBB 32-bits to = to − from − CFlag |
| SSSBB64 | , | //- SSSBB 64-bits to = to − from − CFlag |
| SSSBB128 | , | //- SSSBB 128bits to = to − from − CFlag |

// Instructions SSINCxx signed saturated increment

| | | |
|---|---|---|
| SSINC8 | , | //- SSINC 8-bits to = to + 1 |
| SSINC16 | , | //- SSINC 16-bits to = to + 1 |
| SSINC24 | , | //- SSINC 24-bits to = to + 1 |
| SSINC32 | , | //- SSINC 32-bits to = to + 1 |
| SSINC64 | , | //- SSINC 64-bits to = to + 1 |
| SSINC128 | , | //- SSINC 128bits to = to + 1 |

// Instructions SSDECxx signed saturated decrement

| | | |
|---|---|---|
| SSDEC8 | , | //- SSDEC 8-bits to = to − 1 |
| SSDEC16 | , | //- SSDEC 16-bits to = to − 1 |
| SSDEC24 | , | //- SSDEC 24-bits to = to − 1 |
| SSDEC32 | , | //- SSDEC 32-bits to = to − 1 |
| SSDEC64 | , | //- SSDEC 64-bits to = to − 1 |
| SSDEC128 | , | //- SSDEC 128bits to = to − 1 |

// Instruction SSMULxx Multiply signed saturated integers

| | | |
|---|---|---|
| SSMUL8 | , | //- SSMUL 8-bits to = to * from |
| SSMUL16 | , | //- SSMUL 16-bits to = to * from |
| SSMUL24 | , | //- SSMUL 24-bits to = to * from |
| SSMUL32 | , | //- SSMUL 32-bits to = to * from |
| SSMUL64 | , | //- SSMUL 64-bits to = to * from |
| SSMUL128 | , | //- SSMUL 128bits to = to * from |

// Instruction UIDIVxx Divide signed saturated integers

| | | |
|---|---|---|
| SSDIV8 | , | //- SSDIV 8-bits to = to / from |
| SSDIV16 | , | //- SSDIV 16-bits to = to / from |
| SSDIV24 | , | //- SSDIV 24-bits to = to / from |
| SSDIV32 | , | //- SSDIV 32-bits to = to / from |
| SSDIV64 | , | //- SSDIV 64-bits to = to / from |
| SSDIV128 | , | //- SSDIV 128bits to = to / from |

// Instruction USADDxx unsigned saturated addition

| | | |
|---|---|---|
| USADD8 | , | //- USADD 8-bits to = to + from |
| USADD16 | , | //- USADD 16-bits to = to + from |
| USADD24 | , | //- USADD 24-bits to = to + from |
| USADD32 | , | //- USADD 32-bits to = to + from |
| USADD64 | , | //- USADD 64-bits to = to + from |
| USADD128 | , | //- USADD 128bits to = to + from |

// Instruction USADCxx unsigned saturated addition with carry

| | | |
|---|---|---|
| USADC8 | , | //- USADC 8-bits to = to + from + CFlag |
| USADC16 | , | //- USADC 16-bits to = to + from + CFlag |
| USADC24 | , | //- USADC 24-bits to = to + from + CFlag |
| USADC32 | , | //- USADC 32-bits to = to + from + CFlag |
| USADC64 | , | //- USADC 64-bits to = to + from + CFlag |
| USADC128 | , | //- USADC 128bits to = to + from + CFlag |

// Instruction USSUBxx unsigned saturated subtraction

| | | |
|---|---|---|
| USSUB8 | , | //- USSUB 8-bits to = to − from |
| USSUB16 | , | //- USSUB 16-bits to = to − from |
| USSUB24 | , | //- USSUB 24-bits to = to − from |
| USSUB32 | , | //- USSUB 32-bits to = to − from |
| USSUB64 | , | //- USSUB 64-bits to = to − from |
| USSUB128 | , | //- USSUB 128bits to = to − from |

// Instruction USSBBxx unsigned saturated subtract with carry

| | | |
|---|---|---|
| USSBB8 | , | //- USSBB 8-bits to = to − from − CFlag |
| USSBB16 | , | //- USSBB 16-bits to = to − from − CFlag |
| USSBB24 | , | //- USSBB 24-bits to = to − from − CFlag |
| USSBB32 | , | //- USSBB 32-bits to = to − from − CFlag |
| USSBB64 | , | //- USSBB 64-bits to = to − from − CFlag |
| USSBB128 | , | //- USSBB 128bits to = to − from − CFlag |

// Instructions USINCxx unsigned saturated increment

| | | |
|---|---|---|
| USINC8 | , | //- USINC 8-bits to = to + 1 |
| USINC16 | , | //- USINC 16-bits to = to + 1 |
| USINC24 | , | //- USINC 24-bits to = to + 1 |
| USINC32 | , | //- USINC 32-bits to = to + 1 |
| USINC64 | , | //- USINC 64-bits to = to + 1 |
| USINC128 | , | //- USINC 128bits to = to + 1 |

// Instructions USDECxx unsigned saturated decrement

| | | |
|---|---|---|
| USDEC8 | , | //- USDEC 8-bits to = to − 1 |
| USDEC16 | , | //- USDEC 16-bits to = to − 1 |
| USDEC24 | , | //- USDEC 24-bits to = to − 1 |
| USDEC32 | , | //- USDEC 32-bits to = to − 1 |
| USDEC64 | , | //- USDEC 64-bits to = to − 1 |
| USDEC128 | , | //- USDEC 128bits to = to − 1 |

// Instruction USMULxx Multiply unsigned saturated integers

| | | |
|---|---|---|
| USMUL8 | , | //- USMUL 8-bits to = to * from |
| USMUL16 | , | //- USMUL 16-bits to = to * from |
| USMUL24 | , | //- USMUL 24-bits to = to * from |
| USMUL32 | , | //- USMUL 32-bits to = to * from |
| USMUL64 | , | //- USMUL 64-bits to = to * from |
| USMUL128 | , | //- USMUL 128bits to = to * from |

// Instruction UIDIVxx Divide unsigned saturated integers

| | | |
|---|---|---|
| USDIV8 | , | //- USDIV 8-bits to = to / from |
| USDIV16 | , | //- USDIV 16-bits to = to / from |
| USDIV24 | , | //- USDIV 24-bits to = to / from |
| USDIV32 | , | //- USDIV 32-bits to = to / from |
| USDIV64 | , | //- USDIV 64-bits to = to / from |
| USDIV128 | , | //- USDIV 128bits to = to / from |

// Instruction CMPxx

| | | |
|---|---|---|
| CMP8 | , | //- CMP 8-bits Compare to,from |
| CMP16 | , | //- CMP 16-bits Compare to,from |
| CMP24 | , | //- CMP 24-bits Compare to,from |
| CMP32 | , | //- CMP 32-bits Compare to,from |
| CMP64 | , | //- CMP 64-bits Compare to,from |
| CMP128 | , | //- CMP 128bits Compare to,from |

// Instruction TESTxx compare bits(from) and bits(to)

| | | |
|---|---|---|
| TEST8 | , | //- TEST 8-bits Compare to, Bits(from) |
| TEST16 | , | //- TEST 16-bits Compare to, Bits(from) |
| TEST24 | , | //- TEST 24-bits Compare to, Bits(from) |
| TEST32 | , | //- TEST 32-bits Compare to, Bits(from) |
| TEST64 | , | //- TEST 64-bits Compare to, Bits(from) |
| TEST128 | , | //- TEST 128-bits Compare to, Bits(from) |

// Instruction JMP/Jxx Conditional Jumps

| | | |
|---|---|---|
| JMPS | , | //- JMP to address (short jump) |
| JMP | , | //- JMP to address |
| JMPF | , | //- JMP to address (far jump) |
| JZS | , | //- JZ Jump if zero flag (short jump) |
| JZ | , | //- JZ Jump if zero flag |
| JZF | , | //- JZ jump if zero flag (far jump) |
| JNZS | , | //- JNZ jump if not zero flag (short jump) |
| JNZ | , | //- JNZ jump if not zero flag |
| JNZF | , | JNZ jump if not zero flag (far jump) |
| JAS | , | //- JA jump if A > B (short jump) |
| JA | , | //- JA jump if A > B |
| JAF | , | //- JA jump if A > B (far jump) |
| JAES | , | //- JAE jump of A >= B (short jump) |
| JAE | , | //- JAE jump if A >= B |
| JAEF | , | //- JAE jump if A >= B (far jump) |
| JES | , | //- JE jump if A = B (short jump) |
| JE | , | //- JE jump if A = B |
| JEF | , | //- JE jump if A = B (far jump) |
| JBS | , | //- JB jump if A < B (short jump) |
| JB | , | //- JB jump if A < B |
| JBF | , | //- JB jump if A < B (far jump) |
| JBES | , | //- JBE jump if A <= B (short jump) |
| JBE | , | //- JBE jump if A <= B |
| JBEF | , | //- JBE jump if A <= B (far jump) |
| JSS | , | //- JS jump if A is negative (short jump) |
| JS | , | //- JS jump if A is negative |
| JSF | , | //- JS jump if A is negative (far jump) |
| JNSS | , | //- JNS jump if A is not negative(short jump) |
| JNS | , | //- JNS jump if A is not negative |
| JNSF | , | //- JNS jump if A is not negative(far jump) |
| JOS | , | //- JO jump if overflow flag set(short jump) |
| JO | , | //- JO jump if overflow flag set |
| JOF | , | //- JO jump if overflow flag set(far jump) |
| JNOS | , | //- JNO jump if overflow flag not set(short) |
| JNO | , | //- JNO jump if overflow flag not set |
| JNOF | , | //- JNO jump if overflow flag not set(far) |

// TODO: Add parity etc...
// Instruction CMOVxx Conditional move

| | | |
|---|---|---|
| CMOVZ8 | , | //- CMOVZ 8-bits to= from if zero flag |
| CMOVZ16 | , | //- CMOVZ 16-bits to= from if zero flag |
| CMOVZ24 | , | //- CMOVZ 24-bits to= from if zero flag |
| CMOVZ32 | , | //- CMOVZ 32-bits to= from if zero flag |
| CMOVZ64 | , | //- CMOVZ 64-bits to= from if zero flag |
| CMOVZ128 | , | //- CMOVZ 128bits to= from if zero flag |
| CMOVNZ8 | , | //- CMOVNZ 8-bits to= from if not zero flag |
| CMOVNZ16 | , | //- CMOVNZ 16-bits to= from if not zero flag |
| CMOVNZ24 | , | //- CMOVNZ 24-bits to= from if not zero flag |
| CMOVNZ32 | , | //- CMOVNZ 32-bits to= from if not zero flag |
| CMOVNZ64 | , | //- CMOVNZ 64-bits to= from if not zero flag |
| CMOVNZ128 | , | //- CMOVNZ 128bits to= from if not zero flag |
| CMOVC8 | , | //- CMOVC 8-bits to= from if carry flag |
| CMOVC16 | , | //- CMOVC 16-bits to= from if carry flag |
| CMOVC24 | , | //- CMOVC 24-bits to= from if carry flag |
| CMOVC32 | , | //- CMOVC 32-bits to= from if carry flag |
| CMOVC64 | , | //- CMOVC 64-bits to= from if carry flag |
| CMOVC128 | , | //- CMOVC 128bits to= from if carry flag |
| CMOVNC8 | , | //- CMOVNC 8-bits to= from if not carry flag |
| CMOVNC16 | , | //- CMOVNC 16-bits to= from if not carry flag |
| CMOVNC24 | , | //- CMOVNC 24-bits to= from if not carry flag |
| CMOVNC32 | , | //- CMOVNC 32-bits to= from if not carry flag |
| CMOVNC64 | , | //- CMOVNC 64-bits to= from if not carry flag |
| CMOVNC128 | , | //- CMOVNC 128bits to= from if not carry flag |
| CMOVA8 | , | //- CMOVA 8-bits to= from if above |
| CMOVA16 | , | //- CMOVA 16-bits to= from if above |
| CMOVA24 | , | //- CMOVA 24-bits to= from if above |
| CMOVA32 | , | //- CMOVA 32-bits to= from if above |
| CMOVA64 | , | //- CMOVA 64-bits to= from if above |
| CMOVA128 | , | //- CMOVA 128bits to= from if above |
| CMOVAE8 | , | //- CMOVAE 8-bits to= from if above equal |
| CMOVAE16 | , | //- CMOVAE 16-bits to= from if above equal |
| CMOVAE24 | , | //- CMOVAE 24-bits to= from if above equal |
| CMOVAE32 | , | //- CMOVAE 32-bits to= from if above equal |
| CMOVAE64 | , | //- CMOVAE 64-bits to= from if above equal |
| CMOVAE128 | , | //- CMOVAE 128bits to= from if above equal |
| CMOVB8 | , | //- CMOVB 8-bits to= from if below |
| CMOVB16 | , | //- CMOVB 16-bits to= from if below |
| CMOVB24 | , | //- CMOVB 24-bits to= from if below |
| CMOVB32 | , | //- CMOVB 32-bits to= from if below |
| CMOVB64 | , | //- CMOVB 64-bits to= from if below |
| CMOVB128 | , | //- CMOVB 128bits to= from if below |
| CMOVBE8 | , | //- CMOVBE 8-bits to= from if below equal |
| CMOVBE16 | , | //- CMOVBE 16-bits to= from if below equal |
| CMOVBE24 | , | //- CMOVBE 24 -bits to= from if below equal |
| CMOVBE32 | , | //- CMOVBE 32-bits to= from if below equal |
| CMOVBE64 | , | //- CMOVBE 64-bits to= from if below equal |
| CMOVBE128 | , | //- CMOVBE 128bits to= from if below equal |
| CMOVS8 | , | //- CMOVS 8-bits to= from if signed |
| CMOVS16 | , | //- CMOVS 16-bits to= from if signed |
| CMOVS24 | , | //- CMOVS 24-bits to= from if signed |
| CMOVS32 | , | //- CMOVS 32-bits to= from if signed |
| CMOVS64 | , | //- CMOVS 64-bits to= from if signed |
| CMOVS128 | , | //- CMOVS 128bits to= from if signed |
| CMOVNS8 | , | //- CMOVNS 8-bits to= from if not signed |
| CMOVNS16 | , | //- CMOVNS 16-bits to= from if not signed |
| CMOVNS24 | , | //- CMOVNS 24-bits to= from if not signed |
| CMOVNS32 | , | //- CMOVNS 32-bits to= from if not signed |
| CMOVNS64 | , | //- CMOVNS 64-bits to= from if not signed |
| CMOVNS128 | , | //- CMOVNS 128bits to= from if not signed |
| CMOVP8 | , | //- CMOVP 8-bits to= from if PFlag |
| CMOVP16 | , | //- CMOVP 16-bits to= from if PFlag |
| CMOVP24 | , | //- CMOVP 24-bits to= from if PFlag |
| CMOVP32 | , | //- CMOVP 32-bits to= from if PFlag |
| CMOVP64 | , | //- CMOVP 64-bits to= from if PFlag |
| CMOVP128 | , | //- CMOVP 128bits to= from if PFlag |
| CMOVNP8 | , | //- CMOVNP 8-bits to= from if not PFlag |
| CMOVNP16 | , | //- CMOVNP 16-bits to= from if not PFlag |
| CMOVNP24 | , | //- CMOVNP 24-bits to= from if not PFlag |
| CMOVNP32 | , | //- CMOVNP 32-bits to= from if not PFlag |
| CMOVNP64 | , | //- CMOVNP 64-bits to= from if not PFlag |
| CMOVNP128 | , | //- CMOVNP 128bits to= from if not PFlag |
| CMOVO8 | , | //- CMOVO 8-bits to= from if ordered |
| CMOVO16 | , | //- CMOVO 16-bits to= from if ordered |
| CMOVO24 | , | //- CMOVO 24-bits to= from if ordered |
| CMOVO32 | , | //- CMOVO 32-bits to= from if ordered |
| CMOVO64 | , | //- CMOVO 64-bits to= from if ordered |
| CMOVO128 | , | //- CMOVO 128bits to= from if ordered |
| CMOVNO8 | , | //- CMOVNO 8-bits to= from if not ordered |
| CMOVNO16 | , | //- CMOVNO 16-bits to= from if not ordered |
| CMOVNO24 | , | //- CMOVNO 24-bits to= from if not ordered |
| CMOVNO32 | , | //- CMOVNO 32-bits to= from if not ordered |
| CMOVNO64 | , | //- CMOVNO 64-bits to= from if not ordered |
| CMOVNO128 | , | //- CMOVNO 128bits to= from if not ordered |

//Instruction NOTxx

| | | |
|---|---|---|
| NOT8 | , | //- NOT 8-bits to = to NOT from |
| NOT16 | , | //- NOT 16-bits to = to NOT from |
| NOT24 | , | //- NOT 24-bits to = to NOT from |
| NOT32 | , | //- NOT 32-bits to = to NOT from |
| NOT64 | , | //- NOT 64-bits to = to NOT from |
| NOT128 | , | //- NOT 128bits to = to NOT from |

//Instruction NEGxx

| | | |
|---|---|---|
| NEG8 | , | //- NEG 8-bits to = to NEG from |
| NEG16 | , | //- NEG 16-bits to = to NEG from |
| NEG24 | , | //- NEG 24-bits to = to NEG from |
| NEG32 | , | //- NEG 32-bits to = to NEG from |
| NEG64 | , | //- NEG 64-bits to = to NEG from |
| NEG128 | , | //- NEG 128bits to = to NEG from |

//Instruction ANDxx

| | | |
|---|---|---|
| AND8 | , | //- AND 8-bits to = to AND from |
| AND16 | , | //- AND 16-bits to = to AND from |
| AND24 | , | //- AND 24-bits to = to AND from |
| AND32 | , | //- AND 32-bits to = to AND from |
| AND64 | , | //- AND 64-bits to = to AND from |
| AND128 | , | //- AND 128bits to = to AND from |

//Instruction ORxx

| | | |
|---|---|---|
| OR8 | , | //- OR 8-bits to = to OR from |
| OR16 | , | //- OR 16-bits to = to OR from |
| OR24 | , | //- OR 24-bits to = to OR from |
| OR32 | , | //- OR 32-bits to = to OR from |
| OR64 | , | //- OR 64-bits to = to OR from |
| OR128 | , | //- OR 128bits to = to OR from |

//Instruction XORxx Exclusive OR

| | | |
|---|---|---|
| XOR8 | , | //- XOR 8-bits to = to XOR from |
| XOR16 | , | //- XOR 16-bits to = to XOR from |
| XOR24 | , | //- XOR 24-bits to = to XOR from |
| XOR32 | , | //- XOR 32-bits to = to XOR from |
| XOR64 | , | //- XOR 64-bits to = to XOR from |
| XOR128 | , | //- XOR 128bits to = to XOR from |

//Instruction SHLxx Shift left (B is usually an immediate value)

| | | |
|---|---|---|
| SHL8 | , | //- SHL 8-bits A = A << B |
| SHL16 | , | //- SHL 16-bits A = A << B |
| SHL24 | , | //- SHL 24-bits A = A << B |
| SHL32 | , | //- SHL 32-bits A = A << B |
| SHL64 | , | //- SHL 64-bits A = A << B |
| SHL128 | , | //- SHL 128bits A = A << B |

//Instruction SHRxx Shift right (B is usually an immediate value)

| | | |
|---|---|---|
| SHR8 | , | //- SHR 8-bits A = A >> B |
| SHR16 | , | //- SHR 16-bits A = A >> B |
| SHR24 | , | //- SHR 24-bits A = A >> B |
| SHR32 | , | //- SHR 32-bits A = A >> B |
| SHR64 | , | //- SHR 64-bits A = A >> B |
| SHR128 | , | //- SHR 128bits A = A >> B |

//Instruction ROLxx Roll left (B is usually an immediate value)

| | | |
|---|---|---|
| ROL8 | , | //- ROL 8-bits A = A << B |
| ROL16 | , | //- ROL 16-bits A = A << B |
| ROL24 | , | //- ROL 24-bits A = A << B |
| ROL32 | , | //- ROL 32-bits A = A << B |
| ROL64 | , | //- ROL 64-bits A = A << B |
| ROL128 | , | //- ROL 128bits A = A << B |

//Instruction RORxx Roll right (B is usually an immediate value)

| | | |
|---|---|---|
| ROR8 | , | //- ROR 8-bits A = A >> B |
| ROR16 | , | //- ROR 16-bits A = A >> B |
| ROR24 | , | //- ROR 24-bits A = A >> B |
| ROR32 | , | //- ROR 32-bits A = A >> B |
| ROR64 | , | //- ROR 64-bits A = A >> B |
| ROR128 | , | //- ROR 128bits A = A >> B |

//Instruction SCLxx Shift left with carry

| | | |
|---|---|---|
| SCL8 | , | //- SCL 8-bits A = A << B:Carry |
| SCL16 | , | //- SCL 16-bits A = A << B:Carry |
| SCL24 | , | //- SCL 24-bits A = A << B:Carry |
| SCL32 | , | //- SCL 32-bits A = A << B:Carry |
| SCL64 | , | //- SCL 64-bits A = A << B:Carry |
| SCL128 | , | //- SCL 128bits A = A << B:Carry |

//Instruction SCRxx Shift right with carry

| | | |
|---|---|---|
| SCR8 | , | //- SCR 8-bits A = A >> B:Carry |
| SCR16 | , | //- SCR 16-bits A = A >> B:Carry |
| SCR24 | , | //- SCR 24-bits A = A >> B:Carry |
| SCR32 | , | //- SCR 32-bits A = A >> B:Carry |
| SCR64 | , | //- SCR 64-bits A = A >> B:Carry |
| SCR128 | , | //- SCR 128bits A = A >> B:Carry |

//Instruction RCLxx Roll left with carry

| | | |
|---|---|---|
| RCL8 | , | //- RCL 8-bits A = A << B:Carry |
| RCL16 | , | //- RCL 16-bits A = A << B:Carry |
| RCL24 | , | //- RCL 24-bits A = A << B:Carry |
| RCL32 | , | //- RCL 32-bits A = A << B:Carry |
| RCL64 | , | //- RCL 64-bits A = A << B:Carry |
| RCL128 | , | //- RCL 128bits A = A << B:Carry |

//Instruction RCRxx Roll right with carry

| | | |
|---|---|---|
| RCR8 | , | //- RCR 8-bits A = A >> B:Carry |
| RCR16 | , | //- RCR 16-bits A = A >> B:Carry |
| RCR24 | , | //- RCR 24-bits A = A >> B:Carry |
| RCR32 | , | //- RCR 32-bits A = A >> B:Carry |
| RCR64 | , | //- RCR 64-bits A = A >> B:Carry |
| RCR128 | , | //- RCR 128bits A = A >> B:Carry |

//Instruction IN8/OUT8

| | | |
|---|---|---|
| IN8 | , | //- IN 8-bits ‘A’ = Port(‘B’) |
| OUT8 | , | //- OUT 8-bits Port(‘A’) = ‘B’ |

//Instruction INLxx in from port in little endian format (Byte order 1234)

| | | |
|---|---|---|
| INL16 | , | //- INL 16-bits ‘A’ = Port (‘B’) |
| INL24 | , | //- INL 24-bits ‘A’ = Port (‘B’) |
| INL32 | , | //- INL 32-bits ‘A’ = Port (‘B’) |
| INL64 | , | //- INL 64-bits ‘A’ = Port (‘B’) |
| INL128 | , | //- INL 128bits ‘A’ = Port (‘B’) |

//Instruction INBxx in from port in big endian format (Byte order 4321)

| | | |
|---|---|---|
| INB16 | , | //- INB 16-bits ‘A’ = Port (‘B’) |
| INB24 | , | //- INB 24-bits ‘A’ = Port (‘B’) |
| INB32 | , | //- INB 32-bits ‘A’ = Port (‘B’) |
| INB64 | , | //- INB 64-bits ‘A’ = Port (‘B’) |
| INB128 | , | //- INB 128bits ‘A’ = Port (‘B’) |

// Instruction OUTLxx out to port in little endian format (Byte order 1234)

| | | |
|---|---|---|
| OUTL16 | , | //- OUTL 16-bits Port(‘A’) = ‘B’ |
| OUTL24 | , | //- OUTL 24-bits Port(‘A’) = ‘B’ |
| OUTL32 | , | //- OUTL 32-bits Port(‘A’) = ‘B’ |
| OUTL64 | , | //- OUTL 64-bits Port(‘A’) = ‘B’ |
| OUTL128 | , | //- OUTL 128bits Port(‘A’) = ‘B’ |

// Instruction OUTBxx out to port in big endian format (Byte order 4321)

| | | |
|---|---|---|
| OUTB16 | , | //- OUTB 16-bits Port(‘A’) = ‘B’ |
| OUTB24 | , | //- OUTB 24-bits Port(‘A’) = ‘B’ |
| OUTB32 | , | //- OUTB 32-bits Port(‘A’) = ‘B’ |
| OUTB64 | , | //- OUTB 64-bits Port(‘A’) = ‘B’ |
| OUTB128 | , | //- OUTB 128bits Port(‘A’) = ‘B’ |

// Instruction SETBIT/CLRBIT

| | | |
|---|---|---|
| SETBIT | , | //- SETBIT A = A AND (1 << B) |
| CLRBIT | , | //- CLRBIT A = A AND (XOR (1 << B)) |

// Instruction CALL/INTxx

| | | |
|---|---|---|
| CALLS | , | //- CALL Short with return address on stack |
| CALL | , | //- CALL Address with return address on stack |
| CALLFAR | , | //- CALLFAR Address Far ret address on stack |
| INTX | , | //- INTX Interrupt request flags and far |
| | | // return address on stack |
| | | // Interrupts may not be needed in XPC |

// Instruction RETx

| | | |
|---|---|---|
| RET | , | //- RET Return to Address on stack |
| RETFAR | , | //- RETFAR Return to Far Address on stack |
| IRET | , | //- IRET Return from interrupt Far Address |
| | | // and restore flags on stack |
| | | // IRET may not be needed in XPC |

// Instruction FMOVxx

| | | |
|---|---|---|
| FMOV16 | , | //- FMOV (float)A = (16bit int)B |
| FMOV32 | , | //- FMOV (float)A = (32bit int)B |
| FMOV64 | , | //- FMOV (float)A = (64bit int)B |
| FMOV128 | , | //- FMOV (float)A = (128bit int)B |

// Instruction FIMOVxx

| | | |
|---|---|---|
| FIMOV16 | , | //- FIMOV (16bit int)A = (float)B |
| FIMOV32 | , | //- FIMOV (32bit int)A = (float)B |
| FIMOV64 | , | //- FIMOV (64bit int)A = (float)B |
| FIMOV128 | , | //- FIMOV (128bit int)A = (float)B |

// Instruction FLDx

| | | |
|---|---|---|
| FLDZ | , | //- FLDZ (float)A = 0 |
| FLD1 | , | //- FLD1 (float)A = 1 |
| FLDPI | , | //- FLDPI (float)A = PI |
| | | // (3.1415926535897932384626433832795) |

// Instruction FIMUL, FIDIV, FIADD, FISUB

| | | |
|---|---|---|
| FIMUL | , | //- FIMUL (float)A *= (integer)B |
| FIDIV | , | //- FIDIV (float)A /= (integer)B |
| FIADD | , | //- FIADD (float)A += (integer)B |
| FISUB | , | //- FISUB (float)A −= (integer)B |

// Instruction FMUL, FDIV, FADD, FSUB

| | | |
|---|---|---|
| FMUL | , | //- FMUL (float)A *= (float)B |
| FDIV | , | //- FDIV (float)A /= (float)B |
| FADD | , | //- FADD (float)A += (float)B |
| FSUB | , | //- FSUB (float)A −= (float)B |

// Instruction FSORT, FSIN, FCOS, FTAN, etc.

| | | |
|---|---|---|
| FX2 | , | //- FX2 (float)A = B\hat{ }2 (A = B Squared) |
| FX3 | , | //- FX3 (float)A = B\hat{ }3 (A = B Cubed) |
| FXY | , | //- FXY (float)A = B\hat{ }C |
| FSORT | , | //- FSORT (float)A = SORT(B) (Square Root) |
| FSIN | , | //- FSIN (float)A = SIN(B) |
| FCOS | , | //- FCOS (float)A = COS(B) |
| FSINCOS | , | //- FSINCOS (float)A = SIN(C), B = COS(C) |
| FTAN | , | //- FTAN (float)A = TAN(B) |
| FATAN | , | //- FATAN (float)A = ATAN(C) |

// Instruction FCOMxx/FICOMxx

| | | |
|---|---|---|
| FCOM | , | //- FCOM compare A and B |
| FCOM32 | , | //- FCOM 32-bit compare A and B |
| FCOM64 | , | //- FCOM 64-bit compare A and B |
| FCOM128 | , | //- FCOM 128bit compare A and B |
| FICOM | , | //- FICOM compare A and B |
| FICOM32 | , | //- FICOM 32-bit compare A and B |
| FICOM64 | , | //- FICOM 64-bit compare A and B |
| FICOM128 | , | //- FICOM 128bit compare A and B |

// Note: The unsigned vector arithmatic is slightly different then the
// others. Since they are based on 8bit storage for each dimension the
// actual value is calculated like this: Float = Value / 255. So the actual
// value is between 0 and 1.0. ;)
// Instruction FVADDxx add vectors

| | | |
|---|---|---|
| FVADD24 | , | //- FVADD 24-bit add unsigned vector A += B |
| | | // 24-bit vector = r8, g8, b8 |
| FVADD32 | , | //- FVADD 32-bit add unsigned vector A += B |
| | | // 32-bit vector = r8, g8, b8, a8 |
| FVADD64 | , | //- FVADD 64-bit add float vector A += B |
| | | // 64-bit vector = x16, y16, z16, w16 |
| FVADD128 | , | //- FVADD 128bit add float vector A += B |
| | | // 128bit vector = x32, y32, z32, w32 |

// Instruction FVSUBxx subtract vectors

| | | |
|---|---|---|
| FVSUB24 | , | //- FVSUB 24-bit sub unsigned vector A −= B |
| | | // 24-bit vector = r8, g8, b8 |
| FVSUB32 | , | //- FVSUB 32-bit sub unsigned vector A −= B |
| | | // 32-bit vector = r8, g8, b8, a8 |
| FVSUB64 | , | //- FVSUB 64-bit sub float vector A −= B |
| | | // 64-bit vector = x16, y16, z16, w16 |
| FVSUB128 | , | //- FVSUB 128bit sub float vector A −= B |
| | | // 128bit vector = x32, y32, z32, w32 |

// Instruction FVMULxx multiply vectors

| | | |
|---|---|---|
| FVMUL24 | , | //- FVMUL 24-bit mul unsigned vector A *= B |
| | | // 24-bit vector = r8, g8, b8 |
| FVMUL32 | , | //- FVMUL 32-bit mul unsigned vector A *= B |
| | | // 32-bit vector = r8, g8, b8, a8 |
| FVMUL64 | , | //- FVMUL 64-bit mul float vector A *= B |
| | | // 64-bit vector = x16, y16, z16, w16 |
| FVMUL128 | , | //- FVMUL 128bit mul float vector A *= B |
| | | // 128bit vector = x32, y32, z32, w32 |

// Instruction FVDIVxx divide vectors NOTE: C = Modulus (Remainder)

| | | |
|---|---|---|
| FVDIV24 | , | //- FVDIV 24-bit div unsigned vector A /= B |
| | | // 24-bit vector = r8, g8, b8 |
| FVDIV32 | , | //- FVDIV 32-bit div unsigned vector A /= B |
| | | // 32-bit vector = r8, g8, b8, a8 |
| FVDIV64 | , | //- FVDIV 64-bit div float vector A /= B |
| | | // 64-bit vector = x16, y16, z16, w16 |
| FVDIV128 | , | //- FVDIV 128bit div float vector A /= B |
| | | // 128bit vector = x32, y32, z32, w32 |

MAX_ASM_INSTRUCTIONS //==- This must be the last
enum!!! -==
}; // End enum V_ASM_e
/* EOF */

1.) We claim the algorithm for creating and translating cross-platform compatible software, or the ‘XPC’ algorithm, consists of three parts that are new to the normal process of creating and running software.
a.) The first part is the ‘Advanced virtual platform assembly language’ that the software is actually programmed with. This assembly language is based on all basic and state-of-the-art instructions and allows for other instructions to be added as necessary.
I.) Each instruction in the assembly language is assigned a number in the order it was added to insure that each new version of the ‘Advanced virtual platform assembly language’ would be compatible with the previous versions.
II.) All other programming languages can be compiled into this advanced language instead of a specific CPU language to allow the software to be cross-platform compatible.
b.) The second part is the binary form of the ‘Advanced virtual platform assembly language’. The binary version can be one of three types, all of which include software version information according to the date and time they were created.
I.) The first is the Basic form that includes the software, text, images, or other data the software may need to function.
II.) the second is the professional form that includes all of the first basic form, but also includes information on the software creator, the company name, contact information, and other important information:
III.) The third form is the Certified form that includes all of the information the previous forms include and can also be encrypted and/or compressed for security. This Certified form should only be available after the software is reviewed and designated safe and the company or individual signs a written agreement. This is a security precaution to prevent a virus from spreading to other computers and other platforms.
c.) The third part of the algorithm is the translator. The translator can be included in a system as hardware or software and can be implemented as part of the operating system.
I.) The translator can operate between the operating system and the binary version of various software platforms including the ‘Advanced virtual platform assembly language’, and can also work in parallel with software written in the platforms native language. See FIG. 3 for a visual explanation of how the translator fits into a computer platform.

2.) When a binary created with the ‘Advanced virtual platform assembly language’ is needed the translator is activated and the binary is loaded into memory.
a) The translator then processes the binary by decrypting and or decompressing it if necessary. When all the software is translated the operating system is then given the location of the software in memory and the type of binary it has translated so that the system software can act according to the content of the software and the type of software.
